(19) United States
(12) Patent Application Publication
(10) Pub. No.: US 2013/0257399 A1
(43) Pub. Date: Oct. 3, 2013

(54) CONSTANT ON-TIME SWITCHING CONVERTER AND CONTROL METHOD THEREOF

(71) Applicant: Chengdu Monolithic Power Systems Co., Ltd., (US)

(72) Inventors: Lijie Jiang, Hangzhou (CN); Xiaokang Wu, Hangzhou (CN); Qian Ouyang, Hangzhou (CN); Suhua Luo, Hangzhou (CN); Yuancheng Ren, Hangzhou (CN)

(73) Assignee: CHENGDU MONOLITHIC POWER SYSTEMS CO., LTD., Chengdu (CN)

(21) Appl. No.: 13/706,181

(22) Filed: Dec. 5, 2012

(30) Foreign Application Priority Data
Mar. 27, 2012 (CN) 201210084270.6

(51) Int. Cl. G05F 1/10

(52) U.S. Cl. CPC G05F 1/10
USPC 323/271

(57) ABSTRACT

A controller used in a switching converter. The switching converter includes a switching circuit having at least one switch. The controller comprises an on-time control circuit generating an on-time control signal, a slope compensation circuit generating a slope compensation signal, a comparing circuit, a logic circuit and a load detection circuit. The comparing circuit generates a comparison signal based on the slope compensation signal, a reference signal and the output voltage of the switching circuit. The logic circuit generates a control signal to control the ON and OFF switching of the at least one switch based on the on-time control signal and the comparison signal. The load detection circuit detects the load condition. The slope compensation circuit adjusts the slope compensation signal based on the load condition.

### CROSS-REFERENCE TO RELATED APPLICATION(S)

This application claims the benefit of CN application 201210084270.6, filed on Mar. 27, 2012, and incorporated herein by reference.

### TECHNICAL FIELD

Embodiments of the present invention generally relate to electronic circuits, and more particularly, relate to constant on time switching converter and control methods thereof.

### BACKGROUND

Constant on-time control is widely used in power supply area because of its good transient response, simple structure and smooth mode transition.

FIG. 1 is a block diagram of a prior constant on-time switching converter 100. The switching converter 100 comprises an on-time control circuit 101, a comparing circuit 102, a logic circuit 103 and a switching circuit 104. The switching circuit 104 comprises at least one switch and converts an input voltage VIN into an output voltage VOUT through the ON and OFF switching of the at least one switch. The on-time control circuit 101 generates an on-time control signal COT to control the on-time of one or more switches in the switching circuit 104. The comparing circuit 102 compares the output voltage VOUT with a reference signal VREF to generate a comparison signal SET. The logic circuit 103 generates a control signal CTRL based on the on-time control signal COT and the comparison signal SET, so as to control the ON and OFF switching of the at least one switch in the switching circuit 104.

If the estimated serial resistance (ESR) of the output capacitor in the switching circuit 104 is not big enough, a sub-harmonic oscillation may be generated at the output voltage VOT and make the switching converter 100 unstable. Generally, the switching converter 100 further comprises a slope compensation circuit 105 to avoid the sub-harmonic oscillation. The slope compensation circuit 105 generates a slope compensation signal VSLOPE and provides it to the comparing circuit 102. The comparing circuit 102 generates the control signal CTRL based on the reference signal VREF, the output voltage VOUT and the slope compensation signal VSLOPE.

In order to keep the switching converter stable under various conditions, the slew rate of the slope compensation signal VSLOPE should be higher than a critical value which is determined by the switching frequency, duty cycle and output capacitor. However, the high slew rate of the slope compensation signal VSLOPE may bring poor transient response.

### SUMMARY

The present invention is directed to a controller used in a switching converter. The switching converter comprises a switching circuit having at least one switch. The controller comprises an on-time control circuit generating an on-time control signal, a slope compensation circuit generating a slope compensation signal, a comparing circuit, a logic circuit and a load detection circuit. The comparing circuit generates a comparison signal based on the slope compensation signal, a reference signal and the output voltage of the switching circuit. The logic circuit generates a control signal to control the ON and OFF switching of the at least one switch based on the on-time control signal and the comparison signal. The load detection circuit detects the load condition. The slope compensation circuit adjusts the slope compensation signal based on the load condition.

In one embodiment, the slope compensation circuit resets the slope compensation signal and/or reduces the slew rate of the slope compensation signal if a load transient down is detected.

### BRIEF DESCRIPTION OF THE DRAWINGS

The present invention can be further understood with reference to the following detailed description and the appended drawings, wherein like elements are provided with like reference numerals.

FIG. 1 is a block diagram of a prior constant on-time switching converter 100.

FIG. 2 is a block diagram of a switching converter 200 in accordance with an embodiment of the present invention.

FIG. 3 illustrates a switching converter 300 in accordance with an embodiment of the present invention.

FIG. 4 is a waveform of the switching converter 300 shown in FIG. 3 in steady state in accordance with one embodiment of the present invention.

FIG. 5 is a waveform of the prior switching converter during load transient down.

FIG. 6 is a waveform of the switching converter 300 shown in FIG. 3 during load transient down in accordance with one embodiment of the present invention.

FIG. 7 is a waveform of the switching converter 300 shown in FIG. 3 during load transient down in accordance with another embodiment of the present invention.

FIG. 8 is a waveform of the switching converter 300 shown in FIG. 3 during load transient down in accordance with still another embodiment of the present invention.

FIG. 9 illustrates a slope compensation circuit in accordance with one embodiment of the present invention.

FIG. 10 illustrates a slope compensation circuit in accordance with another embodiment of the present invention.

FIG. 11 illustrates a slope compensation circuit in accordance with still another embodiment of the present invention.

FIG. 12 illustrates a slope compensation circuit in accordance with one embodiment of the present invention.

FIG. 13 is a flow chart of a control method used in a switching converter, in accordance with an embodiment of the present invention.

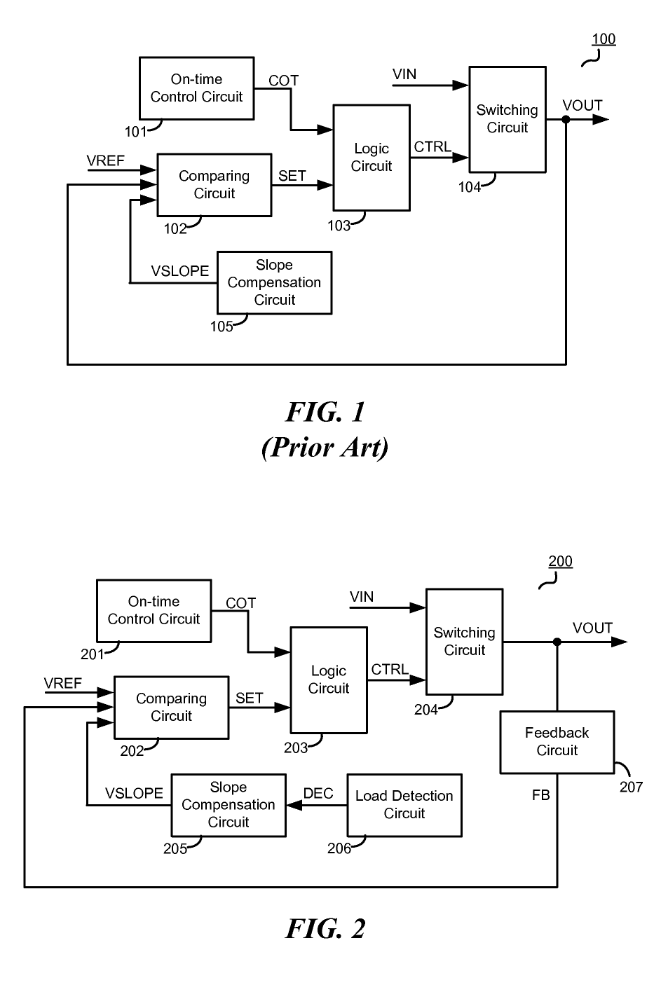

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

FIG. 2 is a block diagram of a switching converter 200 in accordance with an embodiment of the present invention. The switching converter 200 comprises a controller and a switching circuit 204. The switching circuit 204 comprises at least one switch and converts an input voltage VIN into an output voltage VOUT through the ON and OFF switching of the at least one switch. The switching circuit 204 may be configured in any known DC/DC or AC/DC topology, such as BUCK converter, BOOST converter, Flyback converter and so on. The switches in the switching circuit 204 may be any controllable semiconductor device, such as MOSFET (metal oxide semiconductor field effect transistor), IGBT (isolated gate bipolar transistor) and so on.

The controller comprises an on-time control circuit 201, a comparing circuit 202, a logic circuit 203, a slope compensation circuit 205 and a load detection circuit 206. The on-time control circuit 201 generates an on-time control signal COT to control the on-time f one or more switches in the switching circuit 204. The slope compensation circuit 205 generates a slope compensation signal VSLOPE. The comparing circuit 202 is coupled to the slope compensation circuit 205 and the switching circuit 204. The comparing circuit 202 generates a comparison signal SET based on the slope compensation signal VSLOPE, a reference signal VREF and the output voltage VOUT of the switching circuit 204. The logic circuit 203 is coupled to the on-time control circuit 201 and the comparing circuit 202. Based on the on-time control signal COT and the comparison signal SET, the logic circuit 203 generates a control signal CTRL to control the ON and OFF switching of the at least one switch in the switching circuit 204.

The load detection circuit 206 detects the load condition and generates a detection signal DEC based on the load condition. The slope compensation circuit 205 is coupled to the load detection circuit 206 to receive the detection signal DEC, and adjusts the slope compensation signal VSLOPE based on the detection signal DEC. In one embodiment, the slope compensation circuit 205 adjusts the slope compensation signal VSLOPE when a load transient down (load current negative jump) is detected by the load detection circuit 206.

In one embodiment, the load detection circuit 206 compares the current switching period with the switching period in steady state. A load transient down will be detected if the current switching period is longer than the switching period in steady state by a given proportion or a given value. In another embodiment, the load detection circuit 206 detects the load current. A load transient down will be detected if the load current is decreased by a given value. In still another embodiment, the load detection circuit 206 detects the output voltage VOUT of the switching circuit 204. A load transient down will be detected if the output voltage VOUT is increased to a given value. The person skilled in the art will recognize that the load detection circuit 206 may detect the load condition through detecting other parameters related to the load current, and all these detection solutions are included within the spirit and scope of the invention.

In one embodiment, if a load transient down is detected by the load detection circuit 206, the slope compensation circuit 205 will reset the slope compensation signal VSLOPE, such as directly set the slope compensation signal VSLOPE to its maximum value or increase the slope compensation signal VSLOPE in a preset slew rate. In another embodiment, if a load transient down is detected by the load detection circuit 206, the slope compensation circuit 205 will reduce the slew rate of the slope compensation signal VSLOPE. In still another embodiment, if a load transient down is detected by the load detection circuit 206, the slope compensation circuit 205 will reset the slope compensation signal VSLOPE and reduce the slew rate of the slope compensation signal VSLOPE.

In one embodiment, the switching converter 200 further comprises a feedback circuit 207. The feedback circuit 207 has an input terminal and an output terminal. The input terminal of the feedback circuit 207 is coupled to the output terminal of the switching circuit 204 to receive the output voltage VOUT, the output terminal is coupled to the comparing circuit 202 to provide a feedback signal FB representative of the output voltage VOUT. The comparing circuit 202 generates the comparison signal SET based on the slope compensation signal VSLOPE, the reference signal VREF and the feedback signal FB. In one embodiment, the feedback circuit 207 comprises a resistor divider.

Through adjusting the slope compensation signal VSLOPE based on the load condition, the overshoot and ring back of the output voltage VOUT during load transient down are reduced and the transient response of the switching converter is improved. The details will be introduced later.

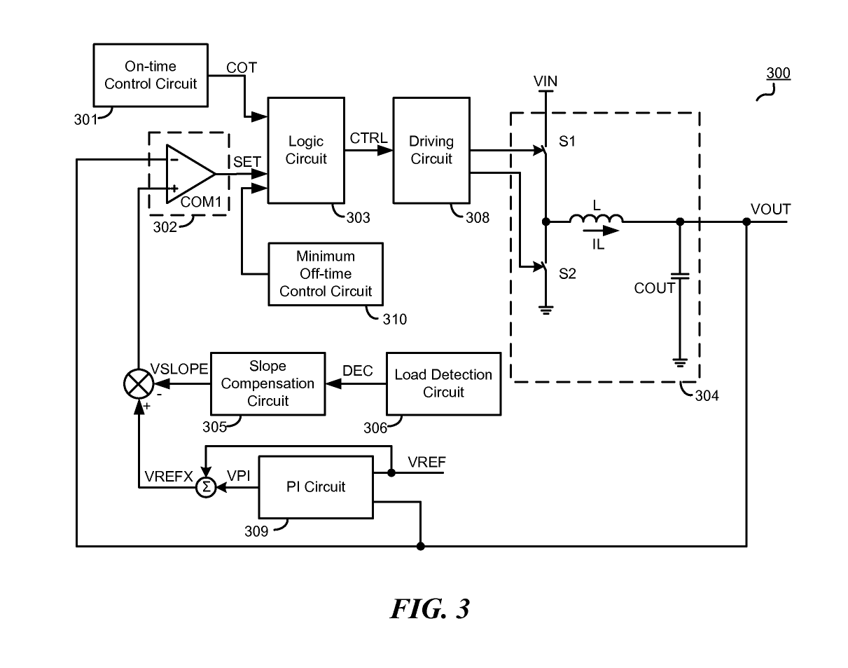

FIG. 3 illustrates a switching converter 300 in accordance with an embodiment of the present invention. The structure of the switching converter 300 is similar to that of the switching converter 200 shown in FIG. 2. The switching circuit 304 is configured in a synchronous BUCK converter. It comprises switches S1, S2, an inductor L and an output capacitor COUT, connected as shown in FIG. 3. In another embodiment, the switch S2 may be replaced by a diode.

The comparing circuit 302 comprises a comparator COM1 having a non-inverting input terminal, an inverting input terminal and an output terminal. The non-inverting input terminal of the comparator COM1 is configured to receive the difference between the reference signal VREF and the slope compensation signal VSLOPE, the inverting input terminal is coupled to the output terminal of the switching circuit 304 to receive the output voltage VOUT. The comparison signal SET is provided at the output terminal. In one embodiment, the slope compensation signal VSLOPE is added to the output voltage VOUT instead of subtracted from the reference signal VREF.

The on-time control circuit 301 generates the on-time control signal COT to control the on-time of the switch S1. In one embodiment, the on-time of the switch S1 is set to a constant value, or a variable value related to the input voltage VIN and/or the output voltage VOUT. The logic circuit 303 is coupled to the on-time control circuit 301 and the comparing circuit 302, and generates the control signal CTRL based on the on-time control signal COT and the comparison signal SET.

In one embodiment, the switching converter 300 further comprises a driving circuit 308. The driving circuit 308 is coupled to the logic circuit 303 to receive the control signal CTRL, and generates driving signals for the switches S1 and S2.

In some applications, a DC error between the output voltage VOUT and the reference signal VREF may be induced by the ESR of the output capacitor COUT. In order to solve this problem, in one embodiment, the switching converter 300 further comprises an error compensation circuit. In the embodiment shown in FIG. 3, the error compensation circuit comprises a proportional integral (PI) circuit 309 and an adder. The proportional integral circuit 309 has a first input terminal, a second input terminal and an output terminal, wherein the first input terminal is configured to receive the reference signal VREF, the second input terminal is coupled to the output terminal of the switching circuit 304 to receive the output voltage VOUT. Based on the reference signal VREF and the output voltage VOUT, the proportional integral circuit 309 provides a proportional integral signal VPI at the output terminal. The adder having a first input terminal, a second input terminal and an output terminal, wherein the first input terminal is configured to receive the reference signal VREF, the second input terminal is coupled to the output terminal of the proportional integral circuit 309 to receive the proportional integral signal VPI, the output terminal is coupled to the comparing circuit 302 to provide a reference signal VREFX. The proportional integral circuit 309 may comprise an error amplifier. In another embodiment, the error compensation circuit is only consisted of an adder which provides a sum of the reference signal VREF and a predetermined offset signal VOFFSET to the comparing circuit 302 as the reference signal VREFX.

In one embodiment, the control circuit further comprises a minimum off-time control circuit 310 to prevent the comparing circuit 302 from being affected by the system noise. The comparison signal SET is disabled by the minimum off-time control circuit 310 during a minimum off-time TOFF_{MIN}. The minimum off-time control circuit 310 is well-known to the person skilled in the art and will not be described in detail.

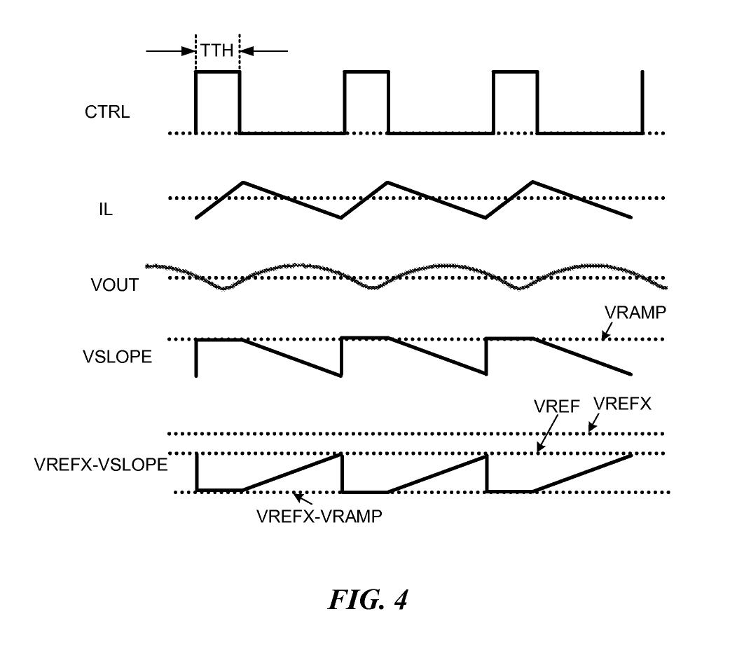

FIG. 4 is a waveform of the switching converter 300 shown in FIG. 3 in steady state in accordance with one embodiment of the present invention. When the control signal CTRL is logical high, the switch S1 is turned on and the switch S2 is turned off. The inductor current IL is increased. When the on-time of the switch S1 reaches a time threshold TTH set by the on-time control circuit 301, the control signal CTRL is changed into logical low. The switch S1 is turned off and the switch S2 is turned on. The inductor current IL is decreased. When the output voltage VOUT becomes smaller than the difference between the reference signal VREFX and the slope compensation signal VSLOPE, the control signal CTRL is changed into logical high. The switch S1 is turned on and the switch S2 is turned off. These processes are repeated.

In the embodiment shown in FIG. 4, the slope compensation signal VSLOPE is set to its maximum value VRAMP when the switch S1 is on and the switch S2 is off. The slope compensation signal VSLOPE is decreased in a given rate when the switch S1 is off and the switch S2 is on. However, the slope compensation signal VSLOPE may be configured in other forms. The time period when the slope compensation signal VSLOPE maintains its maximum value VRAMP may be longer than the time threshold TTH, such as TTH+TOFF_{MIN}. Besides, the slope compensation signal VSLOPE may be a triangular signal which is in phase with the inductor current IL. The slope compensation signal VSLOPE is increased when the switch S1 is on and the switch S2 is off, and decreased when the switch S1 is off and the switch S2 is on.

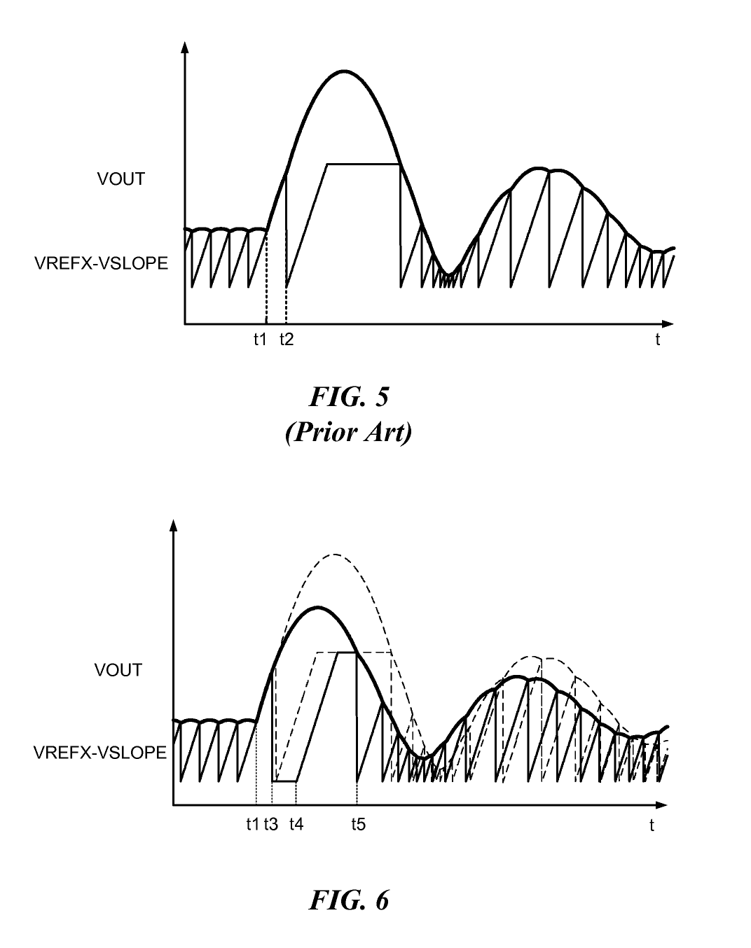

In the embodiments below shown in FIG. 5 to FIG. 7, the slope compensation signal VSLOPE is a saw-tooth signal. It is set to its maximum value VRAMP once the switch S1 is turned on, and is decreased after then. The person skilled in the art can recognize, however, that the slope compensation signals VSLOPE configured in other forms are also applicable.

FIG. 5 is a waveform of the prior switching converter during load transient down. In the prior switching converter, the slope compensation signal will not change along with the load condition. At time t1, the load current is transient down and the output voltage VOUT is increased. Since the rising rate of the output voltage VOUT is smaller than the falling rate of the slope compensation signal VSLOPE, the output voltage VOUT becomes smaller than the signal VREFX-VSLOPE at time t2. The logic circuit will generate an on pulse before the output voltage VOUT reaches the peak value of the overshoot, which will make the overshoot even higher.

FIG. 6 is a waveform of the switching converter 300 shown in FIG. 3 during load transient down in accordance with one embodiment of the present invention, wherein the dotted line is the waveform of the prior switching converter shown in FIG. 5. As shown in the real line, at time t1, the load current is transient down and the output voltage VOUT is increased. At time t3, the load transient down is detected by the load detection circuit 306. The slope compensation circuit 305 reset the slope compensation signal VSLOPE. The slope compensation signal VSLOPE is directly set it to its maximum value VRAM, so the signal VREFX-VSLOPE reaches its minimum value. In one embodiment, the slope compensation signal VSLOPE is decreased in a give rate after some delay, such as at time t4. At time t5, the output voltage VOUT becomes smaller than the signal VREFX-VSLOPE. The switch S1 is turned on and the switch S2 is turned off.

Since the slope compensation signal VSLOPE is reset when the load transient down is detected, the logic circuit 303 does not generate an on pulse before the output voltage VOUT reaches the peak value of the overshoot. The overshoot of the output voltage VOUT is reduced and the transient response of the switching converter is improved.

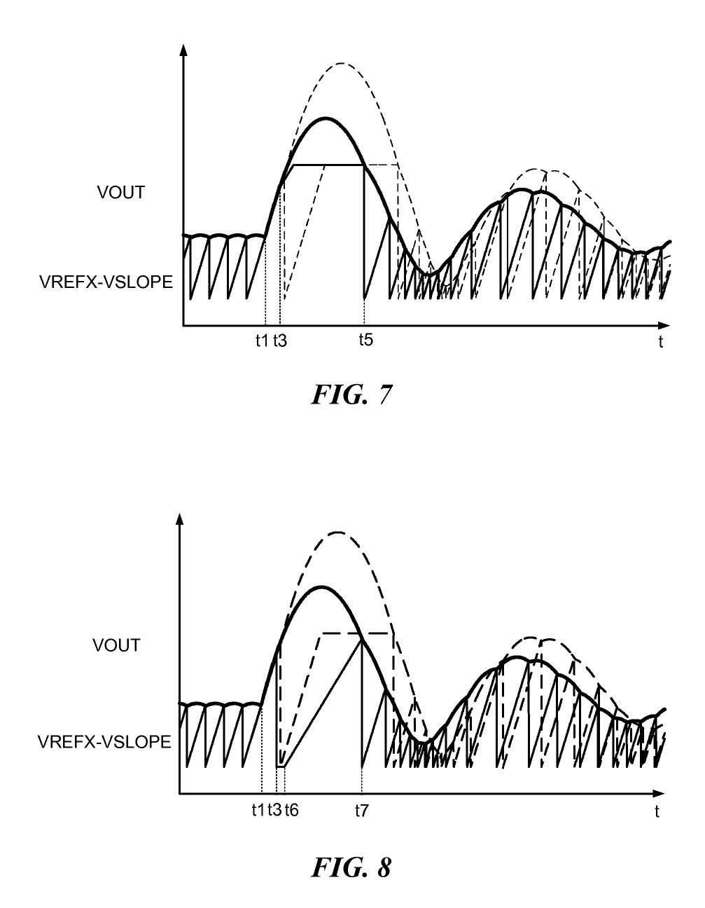

FIG. 7 is a waveform of the switching converter 300 shown in FIG. 3 during load transient down in accordance with another embodiment of the present invention, wherein the dotted line is the waveform of the prior switching converter shown in FIG. 5. As shown in the real line, at time t1, the load current is transient down and the output voltage VOUT is increased. At time t3, the load transient down is detected by the load detection circuit 306. The slope compensation circuit 305 reduces the falling rate of the slope compensation signal VSLOPE, so the rising rate of the signal VREFX-VSLOPE is also reduced. The slope compensation signal VSLOPE is decreased with the reduced slew rate until its minimum value is reached. At time t5, the output voltage VOUT becomes smaller than the signal VREFX-VSLOPE. The switch S1 is turned on and the switch S2 is turned off. The falling rate of the slope compensation signal VSLOPE is resumed.

Since the falling rate of the slope compensation signal VSLOPE is reduced when the load transient down is detected, the logic circuit 303 does not generate an on pulse before the output voltage VOUT reaches the peak value of the overshoot. The overshoot of the output voltage VOUT is reduced and the transient response of the switching converter is improved.

FIG. 8 is a waveform of the switching converter 300 shown in FIG. 3 during load transient down in accordance with still another embodiment of the present invention, wherein the dotted line is the waveform of the prior switching converter shown in FIG. 5. As shown in the real line, at time t1, the load current is transient down and the output voltage VOUT is increased. At time t3, the load transient down is detected by the load detection circuit 306. The slope compensation circuit 305 resets the slope compensation signal VSLOPE and reduces the falling rate of the slope compensation signal VSLOPE. The slope compensation signal VSLOPE is directly set to its maximum value VRAMP, so the signal VREFX-VSLOPE reaches its minimum value. In one embodiment, the slope compensation signal VSLOPE is decreased in the reduced slew rate after some delay, such as at time t6. At time t7, the output voltage VOUT becomes smaller than the signal VREFX-VSLOPE. The switch S1 is turned on and the switch S2 is turned off. The falling rate of the slope compensation signal VSLOPE is resumed.

Since the slope compensation signal VSLOPE is reset and its falling rate is reduced when the load transient down is detected, the logic circuit 303 does not generate an on pulse before the output voltage VOUT reaches the peak value of the overshoot. The overshoot of the output voltage VOUT is reduced and the transient response of the switching converter is improved.

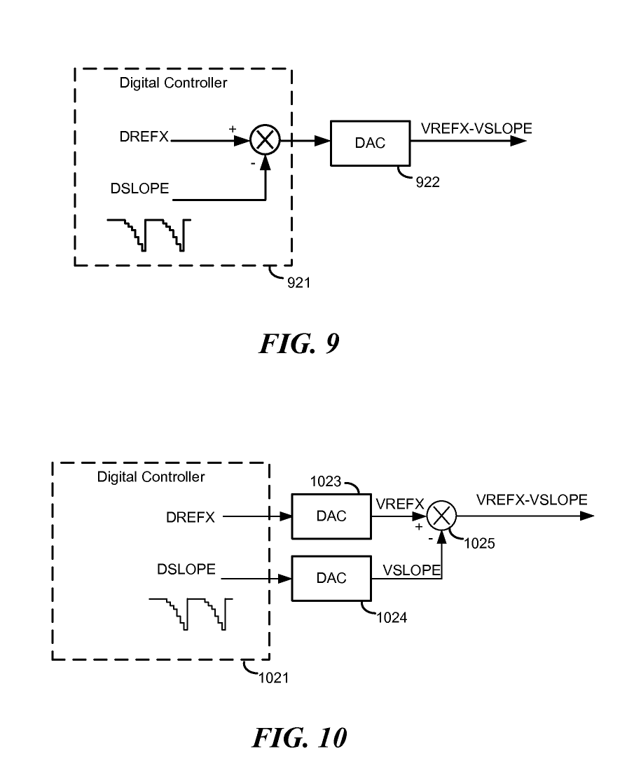

FIG. 9 illustrates a slope compensation circuit in accordance with one embodiment of the present invention. A digital reference signal DREFX and a digital compensation signal DSLOPE are generated by a digital controller 921. The digital controller 921 subtracts the digital compensation signal DSLOPE from the digital reference signal DREFX and provides the difference to a digital analog converter (DAC) 922. The analog signal generated by the DAC 922 is the signal VREFX-VSLOPE. The digital controller 921 can adjust the slew rate of the slope compensation signal VSLOPE or reset the slope compensation signal VSLOPE through adjusting the digital compensation signal DSLOPE.

FIG. 10 illustrates a slope compensation circuit in accordance with another embodiment of the present invention. A digital reference signal DREFX and a digital compensation signal DSLOPE are generated by a digital controller 1021. The digital reference signal DREFX is provided to a DAC 1023. The analog signal generated by the DAC 1023 is the reference signal VREFX. The digital compensation signal DSLOPE is provided to a DAC 1024. The analog signal generated by the DAC 1024 is the slope compensation signal VSLOPE. A calculator 1025 subtracts the slope compensation signal VSLOPE from the reference signal VREFX, and provides the signal VREFX-VSLOPE. The digital controller 1021 can adjust the slew rate of the slope compensation signal VSLOPE or reset the slope compensation signal VSLOPE through adjusting the digital compensation signal DSLOPE.

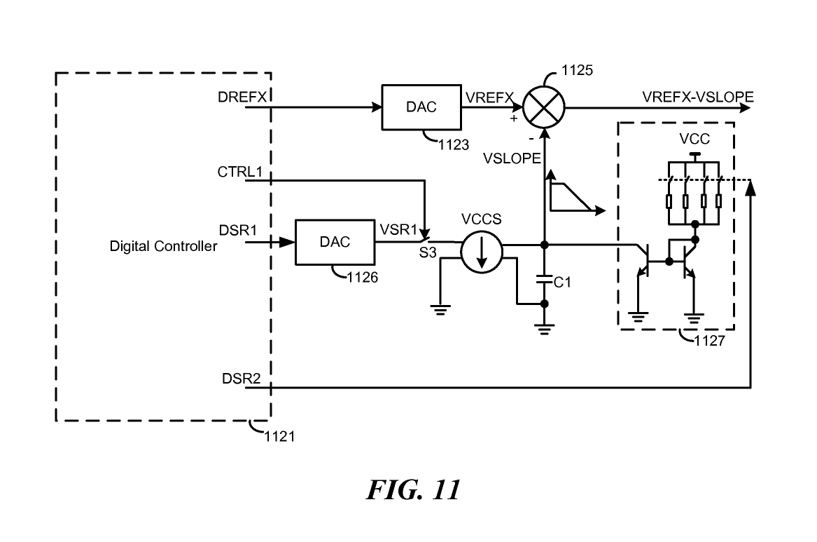

FIG. 11 illustrates a slope compensation circuit in accordance with still another embodiment of the present invention. A digital reference signal DREFX, a control signal CTRL1, digital slew rate signals DSR1 and DSR2 are generated by a digital controller 1121. A DAC 1123 is coupled to the digital controller 1121 to receive the digital reference signal DREFX. The analog signal generated by the DAC 1123 is the reference signal VREFX. A DAC 1126 is coupled to the digital controller 1121 to receive the digital slew rate signal DSR1, and generates an analog signal VSR1. A switch S3 has a first terminal, a second terminal and a control terminal, wherein the first terminal is coupled to the DAC 1126 to receive the signal VSR1, the second terminal is coupled to a voltage controlled current source VCCS. The control terminal of the switch S3 is coupled to the digital controller 1121 to receive the control signal CTRL1. A capacitor C1 has a first terminal and a second terminal wherein the second terminal is grounded. The voltage across the capacitor C1 is the slope compensation signal VSLOPE. The voltage controlled current source VCCS is coupled to the first and second terminals of the capacitor C1. A charge current proportional to the signal VSR1 is provided to the capacitor C1 by the controlled current source VCCS when the switch S3 is on. A discharge circuit 1127 is coupled to the first terminal of the capacitor C1 to provide a discharge current. The discharge circuit 1127 comprises a current mirror and a switching array consisted of a plurality of switches and resistors, connected as shown in FIG. 11. The discharge circuit 1127 is coupled to the digital controller 1121 to receive the digital slew rate signal DSR2. The digital slew rate signal DSR2 controls the ON and OFF switching of the switches in the switching array to adjust the discharge current of the capacitor C1. A calculator 1125 subtracts the slope compensation signal VSLOPE from the reference signal VREFX, and provides the signal VREFX-VSLOPE.

The digital controller 1121 can adjust the slew rate of the slope compensation signal VSLOPE or reset the slope compensation signal VSLOPE through adjusting the digital slew rate signals DSR1 and DSR2. The number of the switches and resistors in the switching array may be determined by the applications.

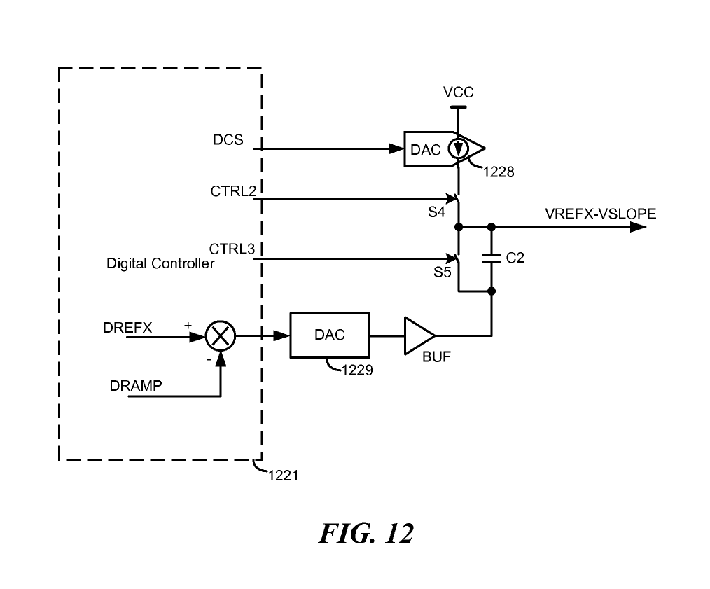

FIG. 12 illustrates a slope compensation circuit in accordance with one embodiment of the present invention. A digital current control signal DCS, control signals CTRL2 and CTRL3, a digital reference signal DREFX and a digital maximum signal DRAMP are generated by a digital controller 1221. The digital controller 1221 subtracts the digital maximum signal DRAMP from the digital reference signal DREFX and provides the difference to a DAC 1229. A digital controlled current source 1228 has a first terminal, a second terminal and a control terminal, wherein the first terminal is coupled to receive a supply voltage VCC, the control terminal is coupled to the digital controller 1221 to receive the digital current control signal DCS. A switch S5 has a first terminal, a second terminal and a control terminal, wherein the first terminal is coupled to the second terminal of the digital controlled current source 1228, the control terminal is coupled to the digital controller 1221 to receive the control signal CTRL2. A switch S5 has a first terminal, a second terminal and a control terminal, wherein the first terminal is coupled to the second terminal of the switch S4, the second terminal is coupled to the output terminal of the DAC 1229. The control terminal of the switch S5 is coupled to the digital controller 1221 to receive the control signal CTRL3. A capacitor C2 has a first terminal and a second terminal, wherein the first terminal is coupled to the second terminal of the switch S4 and the first terminal of the switch S5, the second terminal is coupled to the second terminal of the switch S5 and the output terminal of the DAC 1229. The voltage provided at the first terminal of the capacitor C2 is the signal VREFX-VSLOPE. In one embodiment, the slope compensation circuit further comprises a buffer BUF coupled between the output terminal of the DAC 1229 and the second terminal of the capacitor C2. The digital controller 1221 can adjust the slew rate of the slope compensation signal VSLOPE through adjusting the digital current control signal DCS. The digital controller 1221 can reset the slope compensation signal VSLOPE through adjusting the control signal CTRL3 to turn on the switch S5.

In one embodiment, a digital control method is used in the switching converter. The load detection circuit, proportional integral circuit, on-time control circuit, minimum off-time control circuit and logic circuit shown in FIG. 3 are all realized by a digital controller as shown in FIG. 9-12.

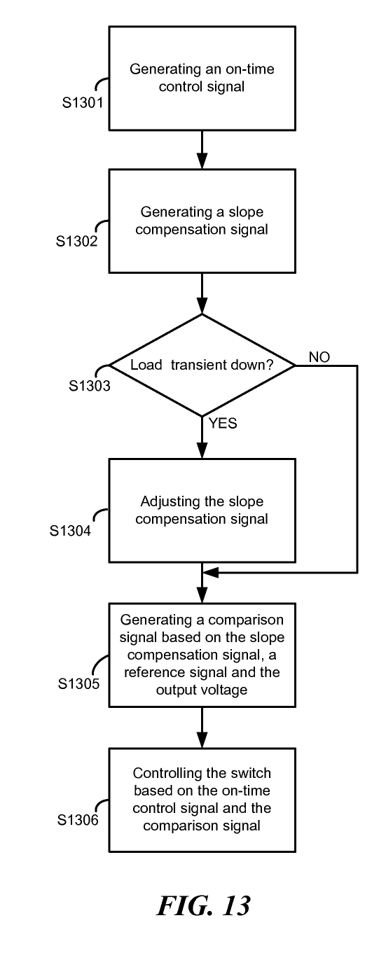

FIG. 13 is a flow chart of a control method used in a switching converter, in accordance with an embodiment of the present invention. The switching converter comprises a switching circuit having at least one switch and configured to provide an output voltage. The control method comprises steps S1301-S1306.

At step S1301, an on-time control signal is generated.

At step S1302, a slope compensation signal is generated.

At step S1303, a load transient down is detected. If the load transient down is detected, go to step S1304, else, go to step S1305.

In one embodiment, the step S1303 comprises comparing the current switching period with the switching period in steady state. The load transient down will be detected if the current switching period is longer than the switching period in steady state by a given proportion or a given value. In another embodiment, the step S1303 comprises detecting the load current. The load transient down will be detected if the load current is decreased by a given value. In still another embodiment, the step S1303 comprises detecting the output voltage of the switching circuit. The load transient down will be detected if the output voltage is increased to a given value.

At step S1304, the slope compensation signal is adjusted. In one embodiment, the step S1304 comprises resetting the slope compensation signal and/or reducing the slew rate of the slope compensation signal.

At step S1305, a comparison signal is generated based on the slope compensation signal, a reference signal and the output voltage of the switching circuit. In one embodiment, the step S1305 comprises comparing the difference between the reference signal and the slope compensation signal with the output voltage or a feedback signal representative of the output voltage to generate the comparison signal.

At step S1306, a control signal is generated to control the ON and OFF switching of the at least one switch in the switching circuit based on the on-time control signal and the comparison signal.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A controller used in a switching converter, wherein the switching converter comprises a switching circuit having at least one switch and configured to provide an output voltage, the controller comprises:
an on-time control circuit configured to generate an on-time control signal;
a slope compensation circuit configured to generate a slope compensation signal;
a comparing circuit coupled to the slope compensation circuit and the switching circuit, wherein based on the slope compensation signal, a reference signal and the output voltage of the switching circuit, the comparing circuit generates a comparison signal;
a logic circuit coupled to the on-time control circuit and the comparing circuit, wherein based on the on-time control signal and the comparison signal, the logic circuit generates a control signal to control the ON and OFF switching of the at least one switch in the switching circuit; and
a load detection circuit configured to detect a load condition, wherein based on the load condition, the load detection circuit generates a detection signal; wherein
the slope compensation circuit is coupled to the load detection circuit to receive the detection signal, and wherein the slope compensation circuit adjusts the slope compensation signal based on the detection signal.

2. The controller of claim 1, wherein if a load transient down is detected by the load detection circuit, the slope compensation circuit will reset the slope compensation signal.

3. The controller of claim 1, wherein if a load transient down is detected by the load detection circuit, the slope compensation circuit will reduce the slew rate of the slope compensation signal.

4. The controller of claim 1, wherein if a load transient down is detected by the load detection circuit, the slope compensation circuit will reset the slope compensation signal and reduce the slew rate of the slope compensation signal.

5. The controller of claim 1, wherein the slope compensation circuit comprises:
a controllable current source having a first terminal, a second terminal and a control terminal, wherein the first terminal is coupled to receive a supply voltage;
a first switch having a first terminal, a second terminal and a control terminal, wherein the first terminal is coupled to the second terminal of the controllable current source;
a capacitor having a first terminal and a second terminal, wherein the first terminal is coupled to the second terminal of the first switch; and
a second switch having a first terminal, a second terminal and a control terminal, wherein the first terminal is coupled to the second terminal of the first switch and the first terminal of the capacitor, the second terminal is coupled to the second terminal of the capacitor.

6. The controller of claim 1, wherein the comparing circuit comprises a comparator having a first input terminal, a second input terminal and an output terminal, wherein the first input terminal is configured to receive the difference between the reference signal and the slope compensation signal, the second input terminal is configured to receive the output voltage or a feedback signal representative of the output voltage, and wherein based on the signals received at the first input terminal and the second input terminal, the comparator provides the comparison signal at the output terminal.

7. The controller of claim 1, further comprising:
a proportional integral circuit having a first input terminal, a second input terminal and an output terminal, wherein the first input terminal is configured to receive the reference signal, the second input terminal is configured to receive the output voltage or a feedback signal representative of the output voltage, and wherein based on the signals received at the first input terminal and the second input terminal, the proportional integral circuit provides a proportional integral signal at the output terminal; and
an adder having a first input terminal, a second input terminal and an output terminal, wherein the first input terminal is configured to receive the reference signal, the second input terminal is coupled to the output terminal of the proportional integral circuit to receive the proportional integral signal, the output terminal of the adder is coupled to the comparing circuit to provide a sum of the reference signal and the proportional integral signal.

8. The controller of claim 1, wherein the load detection circuit compares the current switching period with the switching period in steady state, and wherein a load transient down will be detected if the current switching period is longer than the switching period in steady state by a given proportion or a given value.

9. The controller of claim 1, wherein the load detection circuit detects the load current, and wherein a load transient down will be detected if the load current is decreased by a given value.

10. The controller of claim 1, wherein the load detection circuit detects the output voltage of the switching circuit, and wherein a load transient down will be detected if the output voltage is increased to a given value.

11. A control method used in a switching converter, wherein the switching converter comprises a switching circuit having at least one switch and configured to provide an output voltage, the control method comprises:
generating an on-time control signal;
generating a slope compensation signal;
detecting the load condition;
adjusting the slope compensation signal based on the load condition;
generating a comparison signal based on the slope compensation signal, a reference signal and the output voltage of the switching circuit; and
generating a control signal to control the ON and OFF switching of the at least one switch in the switching circuit based on the on-time control signal and the comparison signal.

12. The control method of claim 11, wherein the step of adjusting the slope compensation signal comprises resetting the slope compensation signal and/or reducing the slew rate of the slope compensation signal if a load transient down is detected.

13. The control method of claim 11, wherein the step of detecting the load condition comprises comparing the current switching period with the switching period in steady state, and wherein a load transient down will be detected if the current switching period is longer than the switching period in steady state by a given proportion or a given value.

14. The control method of claim 11, wherein the step of detecting the load condition comprises detecting the load current, and wherein a load transient down will be detected if the load current is decreased by a given value.

15. The control method of claim 11, wherein the step of detecting the load condition comprises detecting the output voltage of the switching circuit, and wherein a load transient down will be detected if the output voltage is increased to a given value.

16. A controller used in a switching converter, wherein the switching converter comprises a switching circuit having at least one switch and configured to provide an output voltage, the controller comprises:
means for generating an on-time control signal;
means for generating a slope compensation signal;
means for detecting the load condition;
means for generating a comparison signal based on the slope compensation signal, a reference signal and the output voltage of the switching circuit; and
means for generating a control signal to control the ON and OFF switching of the at least one switch in the switching circuit based on the on-time control signal and the comparison signal; wherein
the means for generating the slope compensation signal adjusts the slope compensation signal based on the load condition.

17. The controller of claim 16, wherein the means for generating the slope compensation signal resets the slope compensation signal and/or reduces the slew rate of the slope compensation signal if a load transient down is detected.

18. The controller of claim 16, wherein the means for detecting the load condition compares the current switching period with the switching period in steady state, and wherein a load transient down will be detected if the current switching period is longer than the switching period in steady state by a given proportion or a given value.

19. The controller of claim 16, wherein the means for detecting the load condition detects the load current, and wherein a load transient down will be detected if the load current is decreased by a given value.

20. The controller of claim 16, wherein the means for detecting the load condition detects the output voltage of the switching circuit, and wherein a load transient down will be detected if the output voltage is increased to a given value.
